(19) United States
(12) Patent Application Publication
(10) Pub. No.: US 2002/0175802 A1
(43) Pub. Date: Nov. 28, 2002

(54) Sensor with a planar effective sensor surface

(76) Inventor: Eberhard Horlebein, Aschaffenburg (DE)

Correspondence Address: ABB Automation Inc., 29801 Euclid Avenue - 4U6, Wickliffe, OH, 44092-1898, US

(21) Appl. No.: 09/865,116

(22) Filed: May 24, 2001

(51) Int. Cl. H01C 3/04

(52) U.S. Cl. 338/25

(57) ABSTRACT

A sensor with a planar effective sensor surface, for direct contact with the measuring medium. To achieve the effect that the sensor surfaces or the surfaces of the passivation layer applied to them are much less susceptible to dirt, the sensor surface is coated with a nanostructured surface, or a passivation layer, of reduced adhesiveness, structured in a way similar to the surface of a lotus leaf.

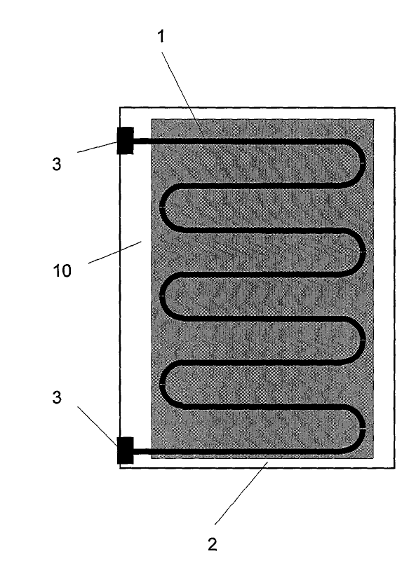

### 1. FIELD OF THE INVENTION

This invention relates to a sensor and more particularly to a sensor with a planar effective sensor surface for direct contact with the measuring medium.

### 2. DESCRIPTION OF THE PRIOR ART

Temperature sensors of a planar configuration are disclosed by the prior art. For temperature measurement, what are known as thermocouple elements, comprising metals coupled together, are used for example. In these elements, usually a pure metal and its alloy are brought together at a contact point. Where they contact, the Fermi energy levels, that is, the highest population energy levels in the electronic lattice of the metal, become the same. However, the two metal components behave differently as the temperature rises. This is due to the electronic structure in the respective metallic lattice. Since the temperature and the electronic conditions within the respective metal differ, an electrical voltage which is temperature dependent is produced between the two metal components.

Such temperature sensors are generally very slow-acting, but have the advantage that they can be directly exposed to the measuring medium virtually without any shielding. The reason for this is that the interface that is actually sensitive is the molten separating surface between the two metals. This is consequently not exposed of course to the measuring medium and also not subject to corrosion. However, if exposed to aggressive media for a long time, the initially only superficially acting chemical reaction becomes effective at a greater depth and causes diffusions of metal ions into the interface. In this case such simple thermocouple sensors are also attacked over time and the thermal e.m.f. results, and consequently the temperature values resulting from them, are no longer reliable.

To produce rapidly responding thermometers, use is often made of temperature resistors which are applied as conductor tracks to thin ceramic or insulating layers.

The resistance element is in this case applied to the insulator as a thin metallic conducting path in a meandering form. The fact that the resistance wire is very thin has the effect that it also responds much more quickly to temperature changes or takes on temperature changes much more quickly. The wire material itself is 10 in this case normal wire material with the customary temperature-dependent increase in resistance generally found in metallic conductors.

In addition, what are known as thin-film measuring resistors are disclosed for example by DE 9006967 U1 for use in an anemometer. The substrate material is in this case an electrically insulating material with a small specific heat capacity, on which a metal film, preferably of platinum, is applied and the electrical resistance to be achieved is subsequently structured and trimmed by erosive finishing. Often, such thin-film measuring resistors are subsequently passivated by applying a thin protective layer of silicon oxide. The covering layers are in this case in full contact and level and have a surface somewhat similar to glass. Such a passivation is aimed at achieving the effect that the sensors can also be exposed to aggressive media and are resistant to them.

If, however, such sensors are exposed to the measuring medium, the prevention of a chemically reactive surface reaction is an issue. Another issue, and consequently also another problem, however, is the fact that the surfaces may be soiled in the measuring medium.

The adsorption of thin films of dirt in this case has a very great adverse effect on the thermal coupling. The average operating time of such a sensor, within which it can still achieve adequate measuring results, depends on the area of use and the adhesiveness of the gases or aerosols occurring in the measuring medium. Cleaning with water or water vapor without using any additional mechanical or chemical means does not accomplish adequate cleaning of the sensor surfaces or of the passivation surfaces.

The present invention is consequently based on the object of developing a sensor of the generic type in such a way that the sensor surfaces or the surfaces of the passivation layer applied to them are much less susceptible to dirt.

The essence of the invention is that the sensor surface is coated with a nanostructured surface of reduced adhesiveness, structured in a way similar to the surface of a lotus leaf. It is known of the surface of a lotus leaf that microstructures in the micrometer and nanometer range virtually eliminate the adhesiveness on the surfaces. That is to say, even pasty, otherwise extremely adherent substances cannot permanently adhere to the surface. Since, for this reason, water also cannot adhere on the surface, wetting for example with water vapor only achieves the effect that particles which happen to be adhering, perhaps only by static forces, immediately flow away from the surface.

Such nanostructured surfaces of reduced adhesiveness may in this case be applied either in the form of special coatings, which form a correspondingly structured surface when they cure, or in the form of coatings which are subsequently microstructured by an ion gun or an electron beam or a laser beam.

In the configuration according to the present invention, a sensor which is designed as a temperature sensor is provided. A further configurational possibility is to design or structure the sensor in the appropriate way for an anemometer arrangement. In a further advantageous configuration, it is provided that the sensor is directly exposed to the measuring medium without a protective covering.

Such thin-film measuring resistors have a very rapid temperature response on account of their low specific heat capacity and their direct exposure to the measuring medium. In other words, the temperature-measuring elements are not slow-acting but relatively quick-acting.

In a further advantageous configuration, it is specified that, to be able to register high temperatures, the nanostructured layer consists of nanostructured ceramic. Of course it is also possible here to use ceramic coatings which do not have to be subsequently nanostructured but after the drying process automatically become fissured in their surface on account of their material properties, in the described nanostructured way, with the described lotus leaf effect.

In a further configuration, however, it is also possible to use temperature-resistant polymers, which are either subsequently microstructured or, by adding an appropriate agent, after application of the same undergo microstructuring during drying out.

When used for measuring, this means that, for example when measuring in flue gas, the sensor surfaces of conventional sensors soil extremely quickly. This has the result that the sensors usually cannot be directly exposed to the measuring medium at all. The present sensor, according to the invention, can however be directly exposed to the measuring medium. The otherwise extremely adherent soot particles remain only temporarily deposited on the surface, if at all, instead being detached again from the said surface, on which they in any case scarcely produce any adhesion, by water vapor present in the flue gas. When used in flowing media, the sensor is, as it were, absolutely self-cleaning.

Consequently, chemically resistant sensors of this type can be produced in an extremely simple way and their measuring accuracy is maintained throughout the operating period and the measurement result remains reliable.

### SUMMARY OF THE INVENTION

A sensor that has a planar effective sensor surface for direct contact with a measuring medium. The sensor surface or the sensor is coated with a nanostructured surface, or a passivation layer, of reduced adhesiveness, structured in a way similar to the surface of a lotus leaf.

### DESCRIPTION OF THE DRAWING

The only drawing FIGURE shows an embodiment for the present invention.

### DESCRIPTION OF THE PREFERRED EMBODIMENT(S)

The only drawing FIGURE shows a sensor 1 as a temperature-measuring resistor, of the thin-film sensor type. In this case, the sensor 1 or the temperature-measuring resistor has been applied in a meandering form as thin conductor tracks to a ceramic support 10 of small specific heat capacity. In addition, the sensor surface, i.e. the temperature-measuring resistor 1, has then been coated in a way according to the invention with a nanostructured passivation layer 2 of reduced adhesiveness, similar to the surface of a lotus leaf. To maintain the good thermal transmission, this layer must of course still be made extremely thin. At the same time, the nanostructured passivation layer 2 is made to face the measuring medium in the said way.

Thin-film resistors of this type can be used as a temperature sensor or in an anemometer arrangement. The sensor can be directly exposed to the measuring medium and does not need a protective covering. The protective or passivation layers themselves may in this case consist either of ceramic materials or of temperature-resistant polymers. It would also be conceivable to nanostructure the silicon oxide surfaces otherwise used by a corresponding subsequent treatment, as already presented above, on the surface facing the measuring medium in the way specified, in order to achieve the lotus leaf effect with this known composite material as well.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A sensor comprising:
a planar effective sensor surface for direct contact with a measuring medium, said sensor surface or said sensor coated with a nanostructured surface, or a passivation layer, of reduced adhesiveness, structured in a way similar to the surface of a lotus leaf.

2. The sensor of claim 1 wherein said sensor is a temperature sensor.

3. The sensor of claim 1 wherein said sensor is designed for an anemometer arrangement.

4. The sensor of claim 1 wherein said sensor is exposed to said medium to be measured without a protective covering.

5. The sensor of claim 2 wherein said sensor is exposed to said medium to be measured without a protective covering.

6. The sensor of claim 3 wherein said sensor is exposed to said medium to be measured without a protective covering.

7. The sensor of claim 1 wherein to be able to register high temperatures, said nanostructured passivation layer consists of nanostructured ceramic.

8. The sensor of claim 2 wherein to be able to register high temperatures, said nanostructured passivation layer consists of nanostructured ceramic.

9. The sensor of claim 3 wherein to be able to register high temperatures, said nanostructured passivation layer consists of nanostructured ceramic.

10. The sensor of claim 4 wherein to be able to register high temperatures, said nanostructured passivation layer consists of nanostructured ceramic.

11. The sensor of claim 5 wherein to be able to register high temperatures, said nanostructured passivation layer consists of nanostructured ceramic.

12. The sensor of claim 6 wherein to be able to register high temperatures, said nanostructured passivation layer consists of nanostructured ceramic.

13. The sensor of claim 1 wherein to be able to register high temperatures, said nanostructured passivation layer consists of temperature-resistant polymer material.

14. The sensor of claim 2 wherein to be able to register high temperatures, said nanostructured passivation layer consists of temperature-resistant polymer material.

15. The sensor of claim 3 wherein to be able to register high temperatures, said nanostructured passivation layer consists of temperature-resistant polymer material.

16. The sensor of claim 4 wherein to be able to register high temperatures, said nanostructured passivation layer consists of temperature-resistant polymer material.

17. The sensor of claim 5 wherein to be able to register high temperatures, said nanostructured passivation layer consists of temperature-resistant polymer material.

18. The sensor of claim 6 wherein to be able to register high temperatures, said nanostructured passivation layer consists of temperature-resistant polymer material.

19. The sensor of claim 7 wherein to be able to register high temperatures, said nanostructured passivation layer consists of temperature-resistant polymer material.

20. The sensor of claim 8 wherein to be able to register high temperatures, said nanostructured passivation layer consists of temperature-resistant polymer material.

21. The sensor of claim 9 wherein to be able to register high temperatures, said nanostructured passivation layer consists of temperature-resistant polymer material.

22. The sensor of claim 10 wherein to be able to register high temperatures, said nanostructured passivation layer consists of temperature-resistant polymer material.

23. The sensor of claim 11 wherein to be able to register high temperatures, said nanostructured passivation layer consists of temperature-resistant polymer material.

24. The sensor of claim 12 wherein to be able to register high temperatures, said nanostructured passivation layer consists of temperature-resistant polymer material.
